(19) United States
(12) Patent Application Publication
(10) Pub. No.: US 2006/0265121 A1
(43) Pub. Date: Nov. 23, 2006

(54) Navigation system for positioning by personal data

(76) Inventors: Ming-Jen Kuo, Taipei (TW); Ko-Yi Yao, Taoyuan (TW)

Correspondence Address: HARNESS, DICKEY & PIERCE, P.L.C., P.O. BOX 8910, RESTON, VA, 20195, US

(21) Appl. No.: 11/246,134

(22) Filed: Oct. 11, 2005

(30) Foreign Application Priority Data
May 20, 2005 (TW) 94116612

(51) Int. Cl. G01C 21/34

(52) U.S. Cl. 701/209; 701/213; 340/995.19

(57) ABSTRACT

A navigation system for positioning by personal data is provided, which employs a personal database to store more than one personal data. The personal data fields in the personal data at least comprise an address field and a GPS coordinate field corresponding to the address field. The GPS coordinate field stores a GPS coordinate value, and is linked with any data field in the personal data fields by a linking module, to obtain a GPS coordinate value of the GPS coordinate field, thus to conduct a destination positioning and navigating rapidly and directly.

### CROSS REFERENCE TO RELATED APPLICATIONS

This Non-provisional application claims priority under 35 U.S.C. § 119(a) on Patent Application No(s). 94116612 filed in Taiwan on May 20, 2005, the entire contents of which are hereby incorporated by reference.

### BACKGROUND

1. Field of Invention

The present invention relates to a navigation system, and more particularly to a navigation system for positioning by personal data.

2. Related Art

The Global Satellite Navigation System, also known as the Global Positioning System (GPS), has now turned to be further employed in communication products for livelihood, which were confined in military and industry fields before. Generally, GPS products mainly refer to communication products employed in various GPS receivers, such as receivers used in aviation and navigation, vehicle navigation devices, and mountaineering and leisure handheld receivers. Similar to the structures of a mobile phone or a PDA, an ordinary handheld GPS product also has an antenna, a chip set, a cell and the like disposed inside, and keys, a LCD panel and the like disposed outside.

The GPS carries out positioning by employing the settings of 24 satellites around the earth. One vehicle on land requires three satellites to calculate its longitude and latitude coordinates. When the locked position determined by the satellites is signaled to the GPS, the user's location and path will be displayed on the electronic map of the navigation system immediately. Then the navigation system utilizes this information to select an optimal driving path from the city or the highway network, and displays the optimal driving path on the screen of the navigation system through the electronic map, wherein the displayed information may include the user's current location, the direction and distance to the destination, etc.

Recently, the GPS has already become one of the indispensable communication products in daily life. In addition to usage in military, the GPS has been widely applied to the fields of scientific research, navigation positioning, geodetic surveying, resources surveying, etc., and has gradually penetrated into daily life, demonstrating a tremendous application potential and a prosperous outlook. Therefore, the development of the GPS satellite navigation positioning system exerts significant effects on the development of the nation and the improvement of the quality of social life.

The biggest problem of the GPS navigation system is that: a user has to know the information, such as the name of the city or street or the position of the landmark of the destination, before carrying out the navigation, and the navigation system cannot identify the destination if the destination has been set with other information. Again, since the user has to know the objects around the destination before the navigation is carried out, the navigation system cannot conduct the destination positioning and navigating rapidly and directly.

### SUMMARY

In view of the above-mentioned problems, the main object of the present invention is to provide a navigation system for positioning by personal data, and a method for recording personal data fields, thereby to substantially overcome the problems of the prior art.

Therefore, in order to achieve the above objects, a navigation system for positioning by personal data according to the present invention employs a personal database to store more than one personal data. The personal data fields in the personal data at least comprise an address field and a GPS coordinate field corresponding to the address field. The GPS coordinate field stores a GPS coordinate value, and may be linked with any data field in the personal fields by a linking module, to obtain a GPS coordinate value of the GPS coordinate field, thus making use of the GPS coordinate value to conduct the destination positioning and navigating rapidly and directly.

In order to achieve the above objects, a method for positioning by personal data is further disclosed in the present invention, which comprises the steps of establishing a personal database to store more than one personal data, wherein the personal data fields at least comprise an address field and a GPS coordinate field corresponding to the address field, which stores the GPS coordinate value corresponding to the personal data; linking the GPS coordinate field with any personal data field in the personal data fields; then establishing an electronic map database to store a plurality of map images and data related to the map images; inputting an instruction corresponding to any personal data field in the personal data fields; then determining the coordinates of the user's current location by a GPS positioning module; obtaining a GPS coordinate value corresponding to the instruction in accordance with the input instruction, and programming an optimal path; then receiving the optimal path and the user's current location to obtain a corresponding electronic map, and to generate a navigating message; and finally displaying the navigating message.

The object according to the present invention is that, when the data input, done by the user, is the information of any personal data field in the personal data fields, the positioning navigation system will obtain a GPS coordinate value corresponding to the personal data in the personal data fields, to provide a more rapid and precise positioning navigation.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below illustration only, and thus is not limitative of the present invention, wherein:

FIG. 1 is a system block diagram of a navigation system for positioning by personal data according to the present invention; and

FIG. 2 is a flow chart of a method for recording personal data fields according to the present invention.

### DETAILED DESCRIPTION

To further appreciate the objects, constructions, characteristics, and functions of the present invention, they are illustrated hereinafter in great detail with reference to the embodiments.

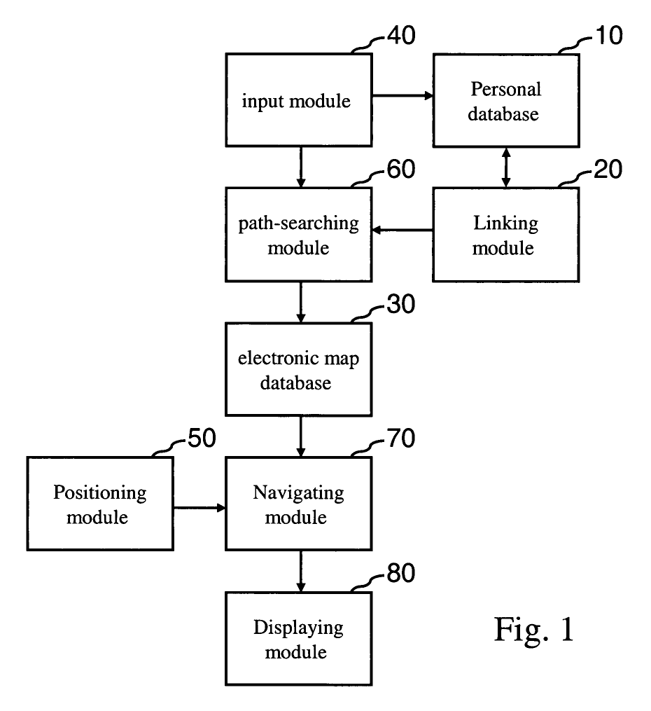

FIG. 1 shows a system block diagram of a navigation system for positioning by personal data, which comprises a personal database 10, a linking module 20, an electronic map database 30, an input module 40, a positioning module 50, a path-searching module 60, a navigating module 70, and a displaying module 80.

First, a personal database 10 and an electronic map database 30 are established. The personal database 10 is used to store more than one personal data, and the personal data fields in the personal data at least comprise an address field and a GPS coordinate field corresponding to the address field. The GPS coordinate field stores a GPS coordinate value, and may be linked with any data field in the personal data fields by a linking module 20, to obtain a GPS coordinate value corresponding to the GPS coordinate field.

The personal data fields may comprise, for example, a name field, a phone number field, an address field, an E-mail address field, a birthday field, etc. In addition, other fields representing the personal data, such as a pet name, a nickname, and a representative number may also be included.

The electronic map database 30 stores a plurality of map images and data, related to the map images, wherein the data related to the map images comprise a map coordinate value, a city name, and a road name.

The user inputs an instruction by the input module 40, which may be the data of any personal data field in the personal data or the related message in the electronic map. The positioning module 50 determines the coordinates of the user's current location, which may be set as the starting point of the destination.

The path-searching module 60 obtains any personal data field corresponding to the personal data according to the instruction input, done by the user. The personal data field is linked with the GPS coordinate field by the linking module to obtain the GPS coordinate value of the GPS coordinate field. Then the information related to the electronic map is searched from the electronic map database to set and obtain an optimal path from the coordinates of the user's current location to the GPS coordinate value, corresponding to the instruction.

The navigating module 70 receives the optimal path generated by the path-searching module 60, the information related to the electronic map, and the coordinates of the user's current location to generate a navigating image message, which is displayed by the displaying module 80.

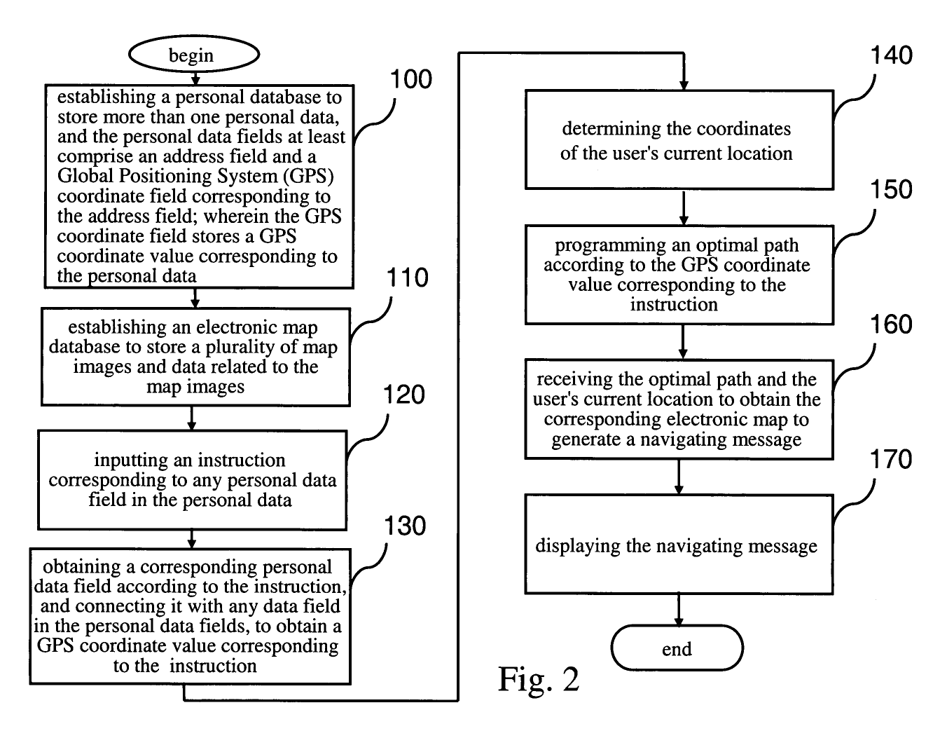

FIG. 2 is a flow chart of a method for recording the personal data fields according to the present invention. First, a personal database is established to store more than one personal data. The personal data fields at least comprise an address field and a GPS coordinate field corresponding to the address field, wherein the GPS coordinate field stores the GPS coordinate value corresponding to the personal data (Step 100), and the GPS coordinate value is obtained by the positioning module through the address field. Next, an electronic map database is established to store a plurality of map images and data related to the map images (Step 110), wherein the data related to the map images may selectively be a map coordinate value, a city name, and a road name. Then, an instruction corresponding to any personal data field in the personal data is inputted (Step 120), wherein the personal data fields may comprise, e.g., a name field, a phone number field, an address field, an E-mail address field, a birthday field, etc. In addition, other fields representing the personal data, such as a pet name, a nickname or a representative number may also be included. A corresponding personal data field is then obtained according to the instruction, and is linked with any data field in the personal data fields, to obtain a GPS coordinate value corresponding to the instruction (Step 130). The coordinates of the user's current location are determined by a GPS positioning module (Step 140). Then an optimal path is programmed according to the GPS coordinate value corresponding to the instruction (Step 150). Further, the optimal path and the user's current location are received to obtain the corresponding electronic map to generate a navigating message (Step 160). Finally, the navigating message is displayed by the displaying module (Step 170), wherein the personal data fields comprise a name field, a phone number field, an address field, an E-mail address field, a birthday field, etc. In addition, other fields representing the personal data, such as a pet name, a nickname or a representative number may also be included.

Therefore, in the present invention, when the data input by a user is the information of any personal data field in the personal data, the positioning navigation system will obtain a GPS coordinate value corresponding to the personal data in the personal data fields, thus providing a more rapid and precise positioning navigation.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A navigation system for positioning by personal data, comprising:
a personal database to store more than one personal data, a plurality of data fields in the personal data comprising an address field and a GPS coordinate field corresponding to the address field, the GPS coordinate field storing a GPS coordinate value which corresponds to the personal data;
a linking module to link the GPS coordinate field with any one of the data fields in the personal data;
an electronic map database to store a plurality of map images and a plurality of data related to the map images;
an input module to input an instruction corresponding to any one of the data fields in the personal data;
a positioning module to determine the coordinates of a user's current location;
a path-searching module to obtain a GPS coordinate value corresponding to the instruction according to the instruction, with an optimal path set by the electronic map database from the user's current location coordinates to the GPS coordinate value corresponding to the instruction;
a navigating module to receive the optimal path, and to obtain a corresponding electronic map according to the optimal path and the user's current location, to generate a navigating message; and
a displaying module to display the navigating message.

2. The navigation system for positioning by personal data of claim 1, wherein the GPS coordinate value is obtained by the positioning module through the address field.

3. The navigation system for positioning by personal data of claim 1, wherein the GPS coordinate field is linked with any one of said data fields in the personal data by the linking module, to obtain the GPS coordinate value in the GPS coordinate field.

4. The navigation system for positioning by personal data of claim 1, wherein the data related to the map images are selected from a group consisting of a map coordinate value, a city name, and a road name.

5. The navigation system for positioning by personal data of claim 1, wherein the data fields are selected from a group consisting of a name field, a phone number field, an address field, an E-mail address field, and a birthday field.

6. A method for positioning personal data, comprising the steps of:
establishing a personal database for storing more than one personal data, a plurality of data fields in the personal data comprising an address field and a GPS coordinate field corresponding to the address field, and the GPS coordinate field storing a GPS coordinate value corresponding to the personal data;
establishing an electronic map database, for storing a plurality of map images and a plurality of data related to the map images;
inputting an instruction corresponding to any one of the data fields in the personal data;
obtaining the corresponding personal data field according to the instruction, and linking it with any one of the data fields in the personal data, to obtain the GPS coordinate value corresponding to the instruction;
determining the coordinates of a user's current location;
programming an optimal path according to the GPS coordinate value corresponding to the instruction;
receiving the optimal path and the user's current location to obtain a corresponding electronic map, to generate a navigating message; and
displaying the navigating message.

7. The method for positioning personal data of claim 6, wherein the GPS coordinate value is obtained by a positioning module through the address field.

8. The method for positioning personal data of claim 6, wherein the GPS coordinate field is linked with any one of the data fields in the personal data, to obtain a GPS coordinate value in the GPS coordinate field.

9. The method for positioning personal data of claim 6, wherein the data related to the map images are selected from a group consisting of a map coordinate value, a city name, and a road name.

10. The method for positioning personal data of claim 6, wherein the data fields are selected from a group consisting of a name field, a phone number field, an address field, an E-mail address field, and a birthday field, and so on.
